(19) United States
(12) Patent Application Publication
(10) Pub. No.: US 2019/0362911 A1
(43) Pub. Date: Nov. 28, 2019

(54) FORCE ACTIVATED ELECTRICAL SWITCH

(71) Applicant: Joyson Safety Systems Acquisition LLC, Auburn Hills, MI (US)

(72) Inventor: David WILSON, Clarkston, MI (US)

(73) Assignee: Joyson Safety Systems Acquisition LLC, Auburn Hills, MI (US)

(21) Appl. No.: 15/989,960

(22) Filed: May 25, 2018

(51) Int. Cl. H01H 3/14; B60N 2/00

(52) U.S. Cl. CPC H01H 3/141; B60N 2/002; H01H 2201/026; H01H 2201/024; H01H 2227/018; H01H 2239/006; H01H 2205/004; H01H 2211/01; H01H 2211/018; H01H 2227/024

(57) ABSTRACT

A force activated electrical switch including a conductor that is screen printed on a first base and a conductor that is screen printed on a second base. The switch includes a plurality of nodes of dielectric material printed in a spaced apart pattern on at least one of the bases. The first base is positioned over the second base so that when a downward force is applied to the first base, the distance between at least a portion of the conductors decreases. The switch may be employed in a system that includes a controller operatively connected to the conductors. The controller includes a sensing circuit or processor configured to detect the presence of the occupant when the force is great enough to cause the conductors to contact one another, thereby activating the electrical switch.

### BACKGROUND

The present application relates to a system using a force activated electrical switch.

### BRIEF DESCRIPTION OF THE DRAWINGS

The features, aspects, and advantages of the present invention will become apparent from the following description, and the accompanying exemplary embodiments shown in the drawings, which are briefly described below.

FIG. 1 is a side view of a vehicle seat containing an occupant detection system that includes an electrical switch.

FIG. 2 is a top view of the occupant detection system of FIG. 1.

FIG. 3 is an exploded view of a sensor pad that includes an electrical switch used in the occupant detection system of FIG. 2.

FIG. 4 is a side view of a base used in the electrical switch of the sensor pad of FIG. 3.

FIG. 5 is top view of the base of FIG. 4.

FIG. 6 is a partial cross-sectional view of the sensor pad of FIG. 5 sectioned through lines 6-6 and including a first base and a second base.

FIG. 7 is a detailed view of the region of the electrical switch circled in FIG. 6.

### DETAILED DESCRIPTION

According to a disclosed exemplary embodiment, the system is directed to an electrical switch that is configured to be activated by a force (e.g., weight, a pressing force, presence of an object, etc.). The electrical switch may comprise a first base, a second base, and a plurality of nodes located on either of the first base and the second base. The plurality of nodes extends away from either the first base or the second base to create a gap or spacer layer between the first base and the second base. In an exemplary embodiment, the plurality of nodes may be arranged in a pattern. The pattern may include space between adjacent nodes. When a predetermined force is applied to the first base or the second base, the gap or spacer layer between the first base and the second base decreases to allow at least a portion of the first base to contact a portion of the second base in the space located between the plurality of nodes. The switch is configured so that when the first base contacts the second base, the electrical switch is activated. The system may be configured so that the force (e.g., pressure, weight, etc.) used to activate the switch can be detected and measured.

Preferably, assembly materials for the electrical switch may include any type of conductive material for the conductors (e.g., copper, conductive inks, conductive fabrics, etc.) and any suitable dielectric material for the plurality of nodes.

According to a disclosed embodiment, the electrical switch may be incorporated into a sensing mat or pad located in a vehicle seat. In another embodiment, the electrical switch may also include a sensing circuit operatively coupled to the first and second bases and configured to sense the presence of an object using a measure of the capacitance between the first and second bases. In another embodiment, the electrical switch may be integrated into other components such as, for example, a vehicle steering wheel, vehicle instrument panel or other components. The structure disclosed is not limited to use as an electrical switch in a vehicle but also may be used as a force activated switch in other environments.

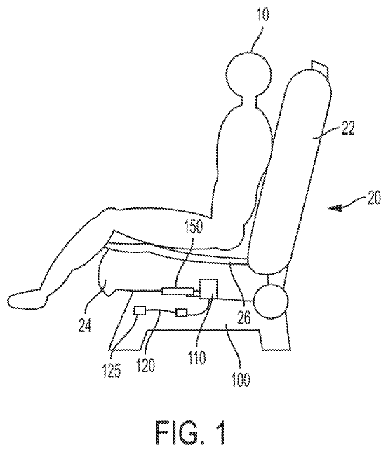

As shown in FIG. 1, an occupant detection system 100 may be located in a vehicle seat 20. The seat may include a seat back 22 and a seat bottom 24. The occupant detection system 100 is preferably located in the seat bottom 24 below a seat cover 26. The detection system 100 includes a sensor pad or mat 150, a controller 110 and a wire harness 120. The harness 120 carries power and connectivity to the vehicles power system and communication bus. The harness 120 is connected to the vehicle's electrical system(s) by a connector 125.

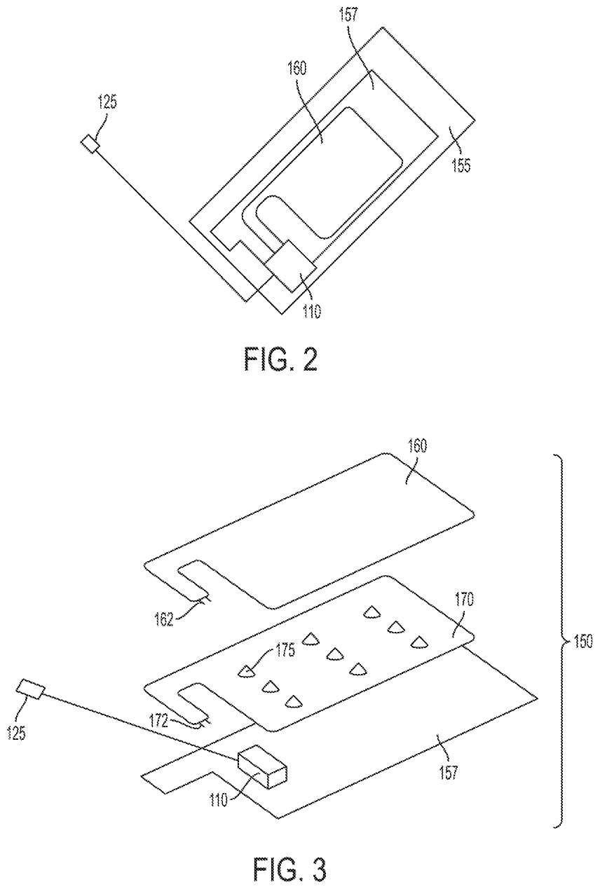

FIG. 2 is a top view of various components of the occupant detection system 100. The system includes an optional supporting lower foundation layer 155. The lower foundation layer 155 may comprise a felt material and may be connected or mounted to a structural component of the vehicle seat such as, for example, the seat pan. An upper foundation layer 157, preferably felt material, is positioned below spaced conductor layers and provides support for the controller 110.

The occupant detection system 100 may include an electrical switch comprising a first base 160 and a second base 170. Each of the first base and second base is preferably a single sheet of plastic type film material. For example, Polyethylene Terephthalate (PET) film may be used for either or both of the bases. Alternatively, other poly based films such as PEN, PC, PI or PEI may be used for the bases. Each of the bases preferably includes a printed conductive material that forms the conductor, conductive trace or “wire” carrying an electronic signal through the conductor layer. Preferably, the conductor is an ink based material that may be printed onto the film. The conductive ink may include, for example, Silver (Ag), Silver/Silver Chloride (Ag/AgCl), and/or Carbon. The conductive ink is preferably printed in a pattern on the film base layer.

As shown in FIG. 3, the first base 160 and the second base 170 are spaced apart or separated by a spacer layer (not labeled). The spacer layer includes dielectric material. Preferably, the dielectric material is an ink based material that may be printed on the second base 170 in a pattern of nodes, dots or mounds 175. The shape of the node may vary. For example, the node may be tapered with a base that has a larger area than the top portion. A cylinder, cube, cone, prism, pyramid or other suitable shape may be used as a shape for the node. In FIG. 3, each of the nodes 175 includes a top portion that contacts the first base 160. As force is applied to the vehicle seat 20 (e.g., the seat bottom 24), the distance between at least a portion of the first base 160 and the second base 170 of the electrical switch is allowed to decrease.

The controller 110 includes a sensing circuit and/or processor that determines a measure of the force that is being applied to decrease the distance between the first and second bases 160 and 170. When a predetermined force is applied, the distance between the first and second base decreases the gap or spacer layer between the first and second base. When the gap or spacer layer between the first and the second base decreases enough, the conductor layer of the first base and the conductor layer of the second base are able to contact one another in the spaces between the plurality of nodes of dielectric material. When the conductor layers contact one another, the electrical switch is activated. In the case where the electrical switch is incorporated into a vehicle occupant detection system, the activation of the electrical switch indicates the presence of an occupant 10 in the vehicle seat 20. The controller 110 may then provide data to the vehicle communication bus via the conductive wires contained in the wire harness 120, which is connected to the vehicle power and communication systems via a connector 125.

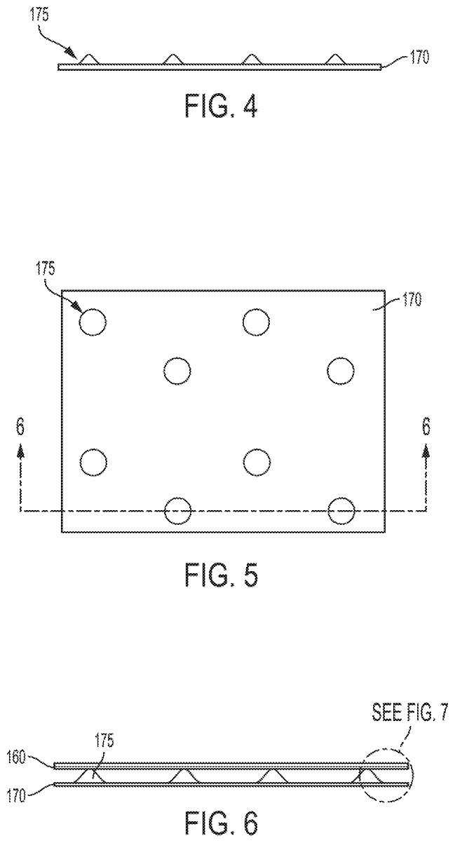

As shown in FIGS. 4 and 5, the dielectric material is arranged on top of the base 170 in a spaced apart pattern that creates a gap or spacer layer between the bases. The pattern of the nodes 175 could be any suitable shape, size and spacing due to the capabilities of the screening process. The pattern of the nodes could be easily adjusted to be suitable for different seat configurations. For example, the nodes could cover less than 20 percent of the surface area of the bases in order to allow for a sufficiently sized volume of the gap between the bases. Decreasing the percentage of the surface area covered by the nodes could make the electrical switch more sensitive.

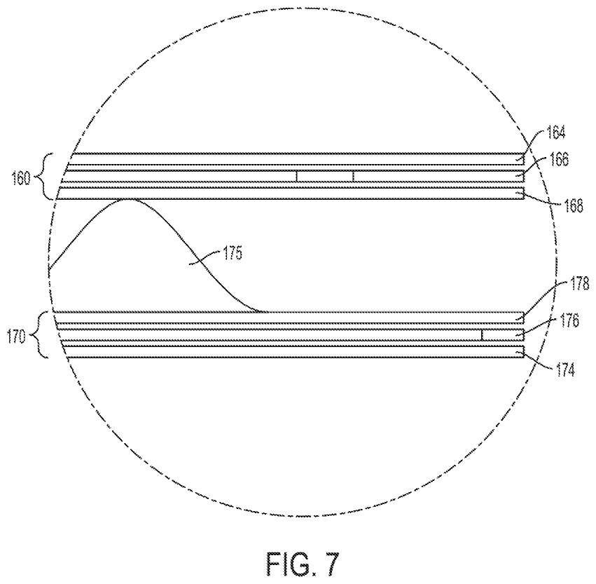

FIG. 7 shows a detailed view of an embodiment of the electrical switch shown in FIG. 6. As shown in FIG. 7, each base 160 and 170 includes three different layers. For example, the base 160 may include a substrate layer 164. A primary conductor layer 166 such as, for example, Ag may be printed on the substrate layer 164. A secondary conductor layer 168, for example, Carbon based ink, may be printed on the primary conductor layer 166. The base 170 may include a similar construction. For example, the base may include a substrate layer 174. A primary conductor layer 176 such as, for example, Ag may be printed on the substrate layer 174. A secondary conductor layer 178, for example, Carbon based ink, may be printed on the primary conductor layer 176. The dielectric nodes 175 may be printed on the substrate layer 174 or on either of the secondary conductor layer 178 or the primary conductor layer 176. Alternatively, the dielectric nodes 175 may be printed on the substrate layer 164 or on either of the secondary conductor layer 168 or the primary conductor layer 166.

The electrical switch and occupant detection system may be used in conjunction with a seat belt reminder system. For example, if the electrical switch is activated due to force applied the occupant detection system may be configured to determine that an occupant is located in the seat. For example, the controller in the occupant detection system may provide a signal to the seat belt reminder system indicating that an occupant is located in the vehicle seat. The seat belt reminder system may receive input from both the occupant detection system and a seat belt buckle sensor. If the system determines that there is an occupant in the seat and the seat belt is not buckled, a seat belt reminder (e.g., audible alarm, warning light, etc.) would be activated to alert the occupant. As mentioned above, the configuration of the electrical switch disclosed herein could be used for other applications as well. These applications include other automotive or vehicle applications as well as configurations in which a relatively low cost and low profile force activated switch could be employed.

The cost and time for development of the electrical switch can be greatly reduced due to the ease of construction and adjustment of the node position. Because the nodes can be screen printed onto a substrate layer and/or a conductor layer, the space between the nodes can be varied and adjusted. For the purposes of analyzing the operation of the system, the nodes of dielectric material can be considered to be incompressible such that there is no requirement to analyze a spring constant for the spacer layer. The spacer layer is essentially the gap between the nodes of dielectric material. The ability to precisely locate the nodes of dielectric material allows the system to provide for more precise measurement of force. This is an advantage over previous systems, which typically used an adhesive with a hole. The hole essentially dictated the amount of force required to activate the switch. In a vehicle, the ability of the present application to precisely locate the nodes can therefore result in more accurate detection of occupants on the seat. The thickness of the entire sensing mat can potentially be reduced to 350 microns or less in order to make the overall system less intrusive in the seat structure. The thickness of the spacer layer could be reduced to 5-8 microns, for example. As mentioned above, the system may be modified to accommodate different seat designs including different seat pan and/or seat spring configurations.

The electrical switch including the plurality of nodes of dielectric material may alternatively be used to measure the capacitance between the conductor layers. The conductor layers may be monitored to determine a measure of the force on the seat 20, which may be associated with a person seated on the seat 20. As shown in FIG. 3, for example, each of the conductors may be connected to the controller 110 by electronic connectors 162, 172. The connectors 162, 172 carry an electronic signal to each of the conductor layers. The electronic signals provided to the conductor layers may be a time varying voltage signal such as, for example, a sinusoidal signal. The controller 110 includes a sensing circuit and/or processor that determine a measure of the capacitance between the upper and lower conductor layers 160, 170. A change in the measure of capacitance may be used by the system 100 to indicate the presence of an occupant 10 in the vehicle seat 20. The controller 110 may then provide data to the vehicle communication bus via the conductive wires contained in the wire harness 120, which is connected to the vehicle power and communication systems via a connector 125. This embodiment is described in greater detail in U.S. patent application Ser. No. 15/646,841 filed on Jul. 11, 2017, the contents of which are hereby incorporated by reference into the present disclosure.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature.

The present disclosure has been described with reference to exemplary embodiments. However, persons skilled in the art will recognize that changes may be made in form and detail without departing from the spirit and scope of the disclosed subject matter. For example, although different exemplary embodiments may have been described as including one or more features providing one or more benefits, it is contemplated that the described features may be interchanged with one another or alternatively be combined with one another in the described exemplary embodiments or in other alternative embodiments. The technology of the present disclosure is complex and thus not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the occupant detection system may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without material departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the exemplary embodiments without departing from the spirit of the present subject matter.

What is claimed is:

1. An electrical switch configured to be used in a vehicle, the electrical switch comprising:
a first base;
a second base; and
a plurality of nodes of dielectric material located on at least one of the first base and the second base, wherein
the plurality of nodes extend away from the at least one of the first base and the second base to thereby create a gap between the first base and the second base;
the plurality of nodes are arranged in a pattern on the at least one of the first base and the second base, the pattern including space between adjacent nodes; and
when a predetermined force is applied to the first base or the second base, the gap between the first base and the second base decreases to allow at least a portion of the first base to contact a portion of the second base in the space located between the plurality of nodes; and
the switch is configured so that when the first base contacts the second base, the electrical switch is activated.

2. The electrical switch of claim 1, wherein the first base and the second base each include a substrate layer and a primary conductor layer.

3. The electrical switch of claim 2, wherein the first base and the second base each include a secondary conductor layer.

4. The electrical switch of claim 2, wherein the electrical switch is activated when the primary conductor layer of the first base contacts the primary conductor layer of the second base.

5. The electrical switch of claim 2, wherein the substrate layer is comprised of a flexible material.

6. The electrical switch of claim 3, wherein the electrical switch is activated when the secondary conductor layer of the first base contacts the secondary conductor layer of the second base.

7. The electrical switch of claim 3, wherein the primary conductor layer is located between the substrate layer and the secondary conductor layer.

8. The electrical switch of claim 3, wherein the primary conductor layer and the secondary conductor layer are screen printed on each of the first base and the second base.

9. The electrical switch of claim 3, wherein at least one of the primary conductor layer and the secondary conductor layer comprises a carbon based ink.

10. The electrical switch of claim 3, wherein at least on of the primary conductor layer and the secondary conductor layer comprises silver.

11. The electrical switch of claim 1, wherein
each of the plurality of nodes is tapered upward from a wider base area that is in contact with either the first base or the second base; and
a top of each of the plurality of nodes contacts another of either the first base or the second base.

12. The electrical switch of claim 1, wherein the electrical switch is configured to be positioned in the vehicle to detect a presence of an occupant.

13. The electrical switch of claim 2, wherein each of the nodes comprise an ink printed on the substrate layer of at least one of the first base and the second base.

14. The electrical switch of claim 3, wherein the primary conductor layer, the secondary conductor layer and the plurality of nodes are printed on a same side of the first base.

15. An occupant detection system comprising an electrical switch and a controller;
wherein the electrical switch comprises:
a first base;
a second base; and
a plurality of nodes of dielectric material located on at least one of the first base and the second base, wherein
the plurality of nodes extend away from the at least one of the first base and the second base to thereby create a gap between the first base and the second base;
the plurality of nodes are arranged in a pattern on the at least one of the first base and the second base, the pattern including space between adjacent nodes; and
when a predetermined force is applied to the first base or the second base, the gap between the first base and the second base decreases to allow at least a portion of the first base to contact a portion of the second base in the space located between the plurality of nodes; and
wherein the controller is configured to output an occupant detection signal when the first base contacts the second base causing the switch to be activated.

16. The occupant detection system of claim 15, wherein the first base and the second base each include a substrate layer and a primary conductor layer.

17. The occupant detection system of claim 16, wherein
each of the first base and the second base include a flexible substrate layer; and
the primary conductor layer is printed on the flexible substrate layer.

18. The occupant detection system of claim 15, wherein
each of the plurality of nodes is tapered upward from a wider base area that is in contact with either the first base or the second base; and
a top of each of the plurality of nodes contacts another of either the first base or the second base.

19. An electrical switch comprising:
a first conductor screen printed on a first base;
a second conductor screen printed on a second base; and
a plurality of nodes of dielectric material located on at least one of the first base and the second base, wherein
each of the plurality of nodes extend to create a gap between the first base and the second base;
the plurality of nodes are arranged in a pattern on the at least one of the first base and the second base that provides spaces between each node;
when a predetermined force is applied to the first base or the second base, the gap between the first base and the second base decreases to allow at least a portion of the first conductor to contact a portion of the second conductor in the spaces between the plurality of nodes; and
when the first conductor contacts the second conductor, the electrical switch is activated.

20. The electrical switch of claim 19, wherein each of the first base and the second base include a flexible substrate layer and wherein the first and second conductors are printed on the substrate layer.
